(19) United States
(12) Patent Application Publication
(10) Pub. No.: US 2025/0067918 A1
(43) Pub. Date: Feb. 27, 2025

(54) STAIRCASE GRATING STRUCTURE FOR INCOUPLING

(71) Applicant: Applied Materials, Inc., Santa Clara, CA (US)

(72) Inventors: Evan WANG, Palo Alto, CA (US); Yingnan LIU, Santa Clara, CA (US); Simon LORENZO, Santa Clara, CA (US); David Alexander SELL, Santa Clara, CA (US)

(21) Appl. No.: 18/812,807

(22) Filed: Aug. 22, 2024

Related U.S. Application Data
(60) Provisional application No. 63/578,917, filed on Aug. 25, 2023.

(51) Int. Cl. F21V 8/00; G02B 27/01

(52) U.S. Cl. CPC G02B 6/0016; G02B 6/0065; G02B 27/0172

(57) ABSTRACT

A waveguide combiner is provided. The waveguide combiner includes a waveguide combiner substrate. The waveguide combiner provides a plurality of staircase structures disposed on the substrate. Each staircase structure comprises a plurality of staircase steps. Each staircase step has a staircase width that is the same. The plurality of staircase steps have a trim width from an initial staircase step to a final staircase step. The plurality of staircase steps includes a top step having a top width.

### CROSS-REFERENCE TO RELATED APPLICATIONS

This application claims priority to U.S. Provisional Patent Application No. 63/578,917, filed Aug. 25, 2023, the entirety of which is herein incorporated by reference.

### BACKGROUND

### Field

Embodiments of the present disclosure generally relate to waveguide combiners for augmented, virtual, and mixed reality. More specifically, embodiments described herein provide waveguide combiners with staircase grating structures.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. Notably, however, conventional augmented reality devices utilize waveguides that include binary gratings, which can reduce optical efficiency.

Accordingly, what is needed in the art is improved waveguide combiners.

### SUMMARY

In one embodiment, a waveguide combiner is provided. The waveguide combiner includes a waveguide combiner substrate. The waveguide combiner provides a plurality of etched staircase structures disposed on the substrate. Each staircase structure comprises a plurality of staircase steps. Each staircase step has a staircase width that is the same. The plurality of staircase steps have a trim width from an initial staircase step to a final staircase step. The plurality of staircase steps includes a top step having a top width.

In another embodiment, a waveguide combiner is provided. The waveguide combiner includes a waveguide combiner substrate. The waveguide combiner provides a plurality of etched staircase structures disposed on the substrate. Each staircase structure comprises a plurality of staircase steps. Each staircase step has a staircase width that is the same. The plurality of staircase steps have a trim width from an initial staircase step to a final staircase step. The plurality of staircase steps includes an intermediate step having an intermediate width that is less than the trim width. The plurality of staircase steps includes a top step having a top width.

In another embodiment, methods of forming waveguide combiners are provided. The methods include depositing a photoresist layer on a patterned hardmask disposed on a device layer. The photoresist layer is exposed to produce a plurality of photoresist segments. The device layer is etched to produce a first step of a blazed grating having a staircase width. The plurality of photoresist segments are trimmed horizontally. The etching of the device layer and the trimming of the plurality of photoresist segments horizontally are repeated to produce an intermediate step. The intermediate step has an intermediate width greater than the staircase width. The plurality of photoresist segments and the patterned hardmask are removed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, may admit to other equally effective embodiments.

FIG. 1A is a perspective, frontal view of a waveguide combiner according to embodiments described herein.

FIG. 1B and FIG. 1C are schematic, cross-sectional views of a waveguide combiner according to embodiments described herein.

FIG. 2 is a flow diagram of a method for forming a waveguide combiner, according to certain embodiments.

FIGS. 3A-3J are schematic, cross-sectional views of a portion of a device material during a method for forming a waveguide combiner according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguide combiners for augmented, virtual, and mixed reality. The waveguide combiners include a staircase structure that is asymmetric, which preferentially directs light towards a desired location of a waveguide. The staircase structure includes a plurality of staircase steps having a trim width from an initial staircase step to a final staircase step and a top step having a top width. In some embodiments, which can be combined with other embodiments, the top width is greater than the trim width to allow for precise control over the amount of light direction. In some embodiments, which can be combined with other embodiments, the top width is less than the trim width.

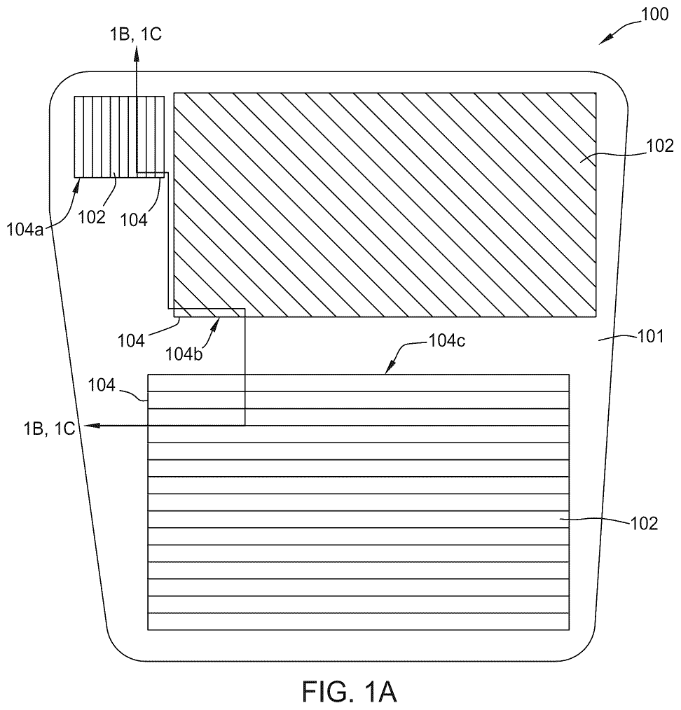

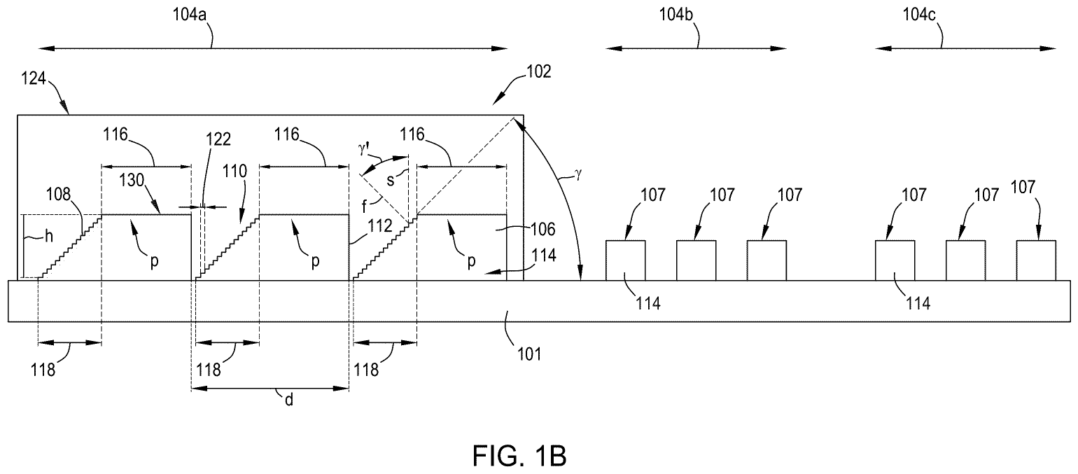

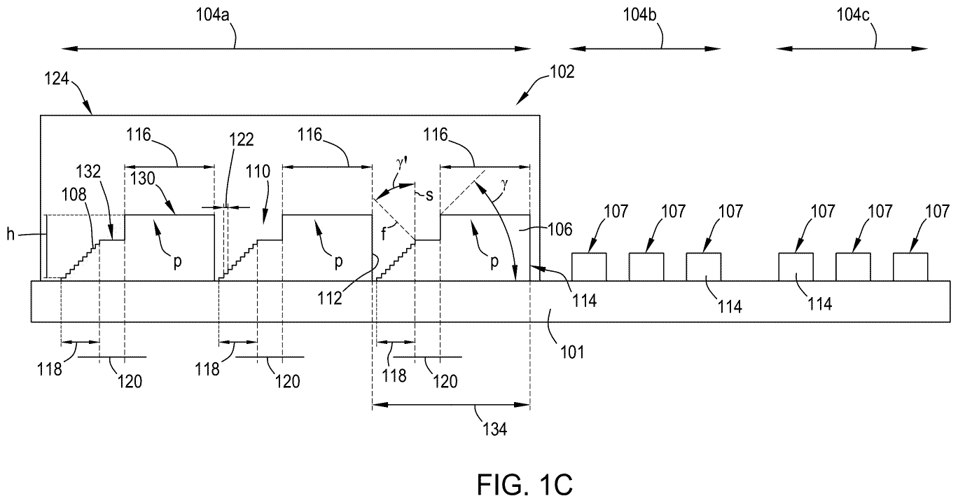

FIG. 1A illustrates a perspective, frontal view of a waveguide combiner 100. It is to be understood that the waveguide combiner 100 described below is an exemplary waveguide combiner. The waveguide combiner 100 is an augmented reality waveguide combiner. The waveguide combiner 100 includes a plurality of device structures 102 disposed on a substrate 101, as shown in FIGS. 1B and 1C. The device structures 102 can be nanostructures having sub-micron dimensions, e.g., nano-sized dimensions, such as critical dimensions less than 1 μm. Regions of the device structures 102 can correspond to one or more gratings 104, such as a first grating 104a, a second grating 104b, and a third grating 104c. The waveguide combiner 100 includes at least the first grating 104a corresponding to an input coupling grating and the third grating 104c corresponding to an output coupling grating. The waveguide combiner 100 can include the second grating 104b corresponding to an intermediate grating. The first grating 104a has staircase structures 106. The second grating 104b and the third grating 104c has device structures 107.

FIG. 1B and FIG. 1C are schematic, cross-sectional views of a waveguide combiner 100. The staircase structures 106 include a staircase surface 108, a sidewall 112, a depth h, and a linewidth d. The depth h corresponds to the height of the sidewall 112 of the staircase structures 106 and the linewidth d corresponds to the distances between sidewalls 112 of adjacent staircase structures. For example, the depth h may include a distance from a top surface of the substrate 101 to a top step 130 of the staircase structure. As a further example, the linewidth d may include a distance between a sidewall of a first staircase structure and a sidewall of a second staircase structure.

The staircase surface 108 has a plurality of staircase steps 110. Each staircase step of the plurality of staircase steps 110 has a staircase width 122 that is the same. For example, the plurality of staircase steps 110 can include 16, 32, 64, or 128 steps, in which each step has a step width that is the same. Each staircase step of the plurality of staircase steps 110 has a staircase height that is the same. For example, the plurality of staircase steps 110 can include 16, 32, 64, or 128 steps, in which each step has a step height that is the same. The staircase width 122 and the staircase height are independent, in which the staircase width 122 and the staircase height can be the same size or a different size, as shown in FIG. 1B.

Alternatively, the staircase width 122 and the staircase height can be a different size. Each staircase step of the plurality of staircase steps 110 has a staircase width 122 that is different. For example, the plurality of staircase steps 110 can include 16, 32, 64, or 128 steps, in which each step has a step width that is different. Each staircase step of the plurality of staircase steps 110 has a staircase height that is different. For example, the plurality of staircase steps 110 can include 16, 32, 64, or 128 steps, in which each step has a step height that is different. Each staircase structure of the plurality of staircase structures has a refractive index of about 1.5 to about 4.0. For example, each staircase structure of the plurality of staircase structures has a refractive index of about 2.65 to about 4.0.

The plurality of staircase steps 110 have a trim width 118 that is defined by an initial staircase step to a final staircase step. The initial staircase step is the first step vertically from the substrate 101. The final staircase step is the last step vertically from the waveguide combiner 100 to a top step 130 or intermediate step 132 is reached, in which the top step 130 is a parallel surface p from the substrate 101, and an intermediate step 132 is a step that is disposed between the final staircase step and the top step 130. The trim width 118 can be less than half of the total width 134 of the staircase structures 106, e.g., less than 50%. The trim width 118 can be greater than half of the total width 134 of the staircase structures 106, e.g., greater than 50%. The trim width 118 can be less than a top width 116 of the staircase structure and greater than an intermediate width 120. The trim width 118 can be greater than a top width 116 of the staircase structure and greater than an intermediate width 120. The top width 116 is defined by the total width of the top step 130. The intermediate width 120, is defined by the total width of the intermediate step 132. The top width 116 can be greater than 50% of the width of the staircase structure 106. The top width 116 can be less than 50% of the width of the staircase structure 106. The top width 116 can be greater than the trim width 118 and the intermediate width 120. The top width 116 can be less than the trim width 118 and the intermediate width 120.

The staircase surface 108 has a staircase angle γ. The staircase angle γ is the angle between the staircase surface 108 and the surface parallel p of the substrate 101, e.g., a horizontal portion of a step of the plurality of steps of the staircase structure. Additionally, an individual staircase angle γ′ is the angle between the surface normal, s, of the substrate 101 and facet normal f of the staircase surface 108. In some embodiments, the staircase angle γ and the individual staircase angle γ′ may be the same or different.

The staircase angle γ′ of two or more staircase structures 106 can be different. The staircase angle γ′ of two or more staircase structures 106 can be the same. The depth h of two or more staircase structures 106 can be different, e.g., different depths. The depth h of two or more staircase structures 106 can be the same. The linewidth d of two or more staircase structures 106 can be different. The linewidths d of one or more staircase structures 106 can be the same.

The substrate 101 can be any substrate used in the art, and can be either opaque or transparent to a chosen wavelength of light, depending for the use of the substrate 101 as a substrate for a waveguide. Substrate selection may include substrates of any suitable material, including, but not limited to, amorphous dielectrics, non-amorphous dielectrics, crystalline dielectrics, polymers, or combinations thereof. In some embodiments, the substrate 101 includes, but is not limited to, a silicon-containing material, a silicon and oxygen containing compound, a germanium-containing material, a indium and phosphide containing compound, a gallium and arsenic containing compound, a gallium and nitrogen containing compound, a carbon-containing material, a silicon and carbon containing compound, a silicon, carbon, and oxygen containing compound, a silicon and nitrogen containing compound, a silicon, oxygen, and nitrogen containing compound, a niobium and oxygen containing compound, and lithium, niobium, and oxygen containing compound, an aluminum and oxygen containing compound, a indium, tin, and oxygen containing compound, a titanium and oxygen containing compound, a lanthanum and oxygen containing compound, a gadolinium and oxygen containing compound, a zinc and oxygen containing compound, a yttrium and oxygen containing compound, a tungsten and oxygen containing compound, a potassium, and oxygen containing compound, a phosphorous and oxygen containing compound, a barium and oxygen containing compound, a sodium and oxygen containing compound, or combinations thereof. In other embodiments, which can be combined with other embodiments described herein, the substrate 101 includes an oxide including one or more of gadolinium, silicon, sodium, barium, potassium, tungsten, phosphorus, zinc, calcium, titanium, tantalum, niobium, lanthanum, zirconium, lithium, or yttrium containing-materials. Example materials of the substrate 101 include silicon (Si), silicon monoxide (SiO), silicon dioxide (SiO₂), silicon carbide (SiC), fused silica, diamond, quartz germanium (Ge), silicon germanium (SiGe), indium phosphide (InP), gallium arsenide (GaAs), gallium nitride (GaN), sapphire, sapphire (Al₂O₃), lithium niobate (LiNbO₃), indium tin oxide (ITO), lanthanum oxide (La₂O₃), gadolinium oxide (Gd₂O₅), zinc oxide (ZnO), yttrium oxide (Y₂O₃), tungsten oxide (WO₃), titatium oxide (TiO₂), zirconium oxide (ZrO₃), sodium oxide (Na₂O), niobium oxide (Nb₂O₅), barium oxide (BaO), potassium oxide (K₂O), phosphorus pentoxide (P₂O₅), calcium oxide (CaO), or combinations thereof. In some embodiments, which can be combined with other embodiments, the substrate can be configured to transmit wavelengths from 100 to 3000 nanometers.

The structure material 114 and the substrate 101 include a different material. The structure material 114 includes, but is not limited to, one or more oxides, carbides, or nitrides of silicon, aluminum, zirconium, tin, tantalum, zirconium, barium, titanium, hafnium, lithium, lanthanum, cadmium, niobium, or combinations thereof. Example materials of the structure material 114 include silicon carbide, silicon oxycarbide, titanium oxide, silicon oxide, vanadium oxide, aluminum oxide, aluminum-doped zinc oxide (AZO), indium tin oxide, tin oxide, zinc oxide, tantalum oxide, silicon nitride, zirconium oxide, niobium oxide, cadmium stannate, silicon oxynitride, barium titanate, diamond like carbon, hafnium oxide, lithium niobate, silicon carbon-nitride, silver, cadmium selenide, mercury telluride, zinc selenide, silver-indium-gallium-sulfur, silver-indium-sulfur, indium phosphide, gallium phosphide, lead sulfide, lead selenide, zinc sulfide, molybdenum sulfide, tungsten sulfide, or combinations thereof.

An encapsulation layer 124 is disposed over the staircase structures of the first grating 104a. The encapsulation layer 124 includes, but is not limited to, aluminum, silver, gold, chromium, silicon nitride, silicon oxide, or combinations thereof. Example of the encapsulation layer 124 includes silicon dioxide, aluminum oxide, magnesium oxide, or combinations thereof. The encapsulation layer 124 may be formed using one or more vapor deposition processes which utilize plasma such as PVD or sputtering processes, a furnace CVD (FCVD) process, a PE-CVD process, a PE-ALD process, or other plasma processes.

In one or more examples, the encapsulation layer 124 may be deposited by a PVD process which includes generating ozone or an oxygen plasma while depositing the encapsulation layer 124. For example, silver may be deposited in a magnetron sputtering PVD chamber using a silicon target and depositing reactively with a plasma containing argon and oxygen (Ar/O₂). The encapsulation layer 124 may have a thickness of about 10 nm to about 1000 nm or greater, such as about 10 nm to about 200 nm.

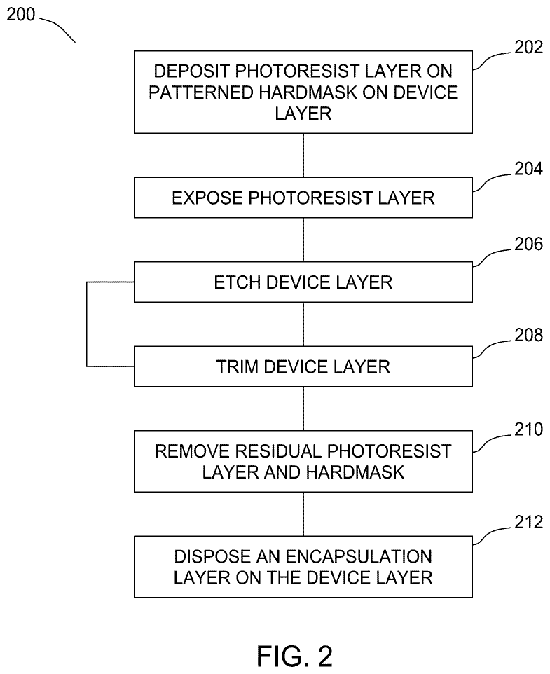

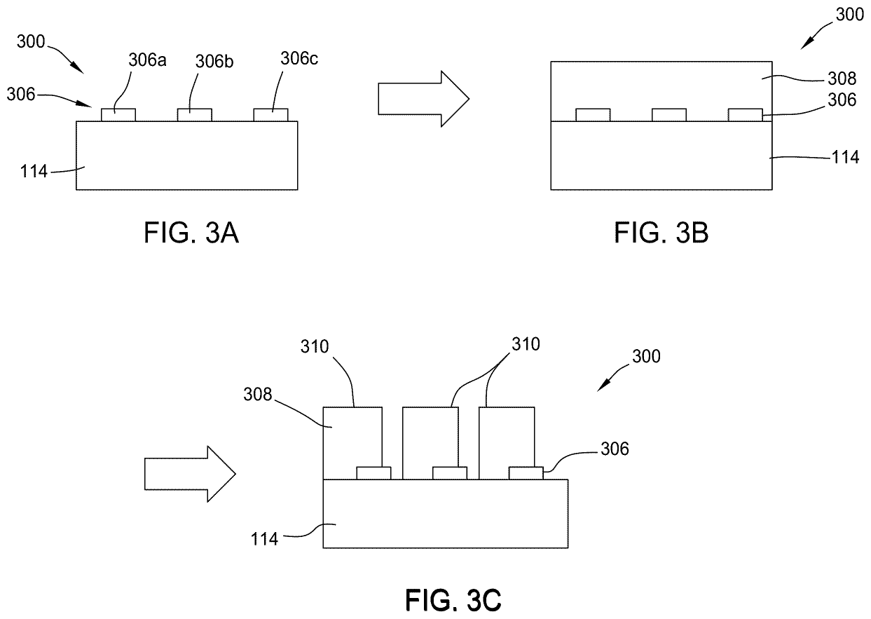

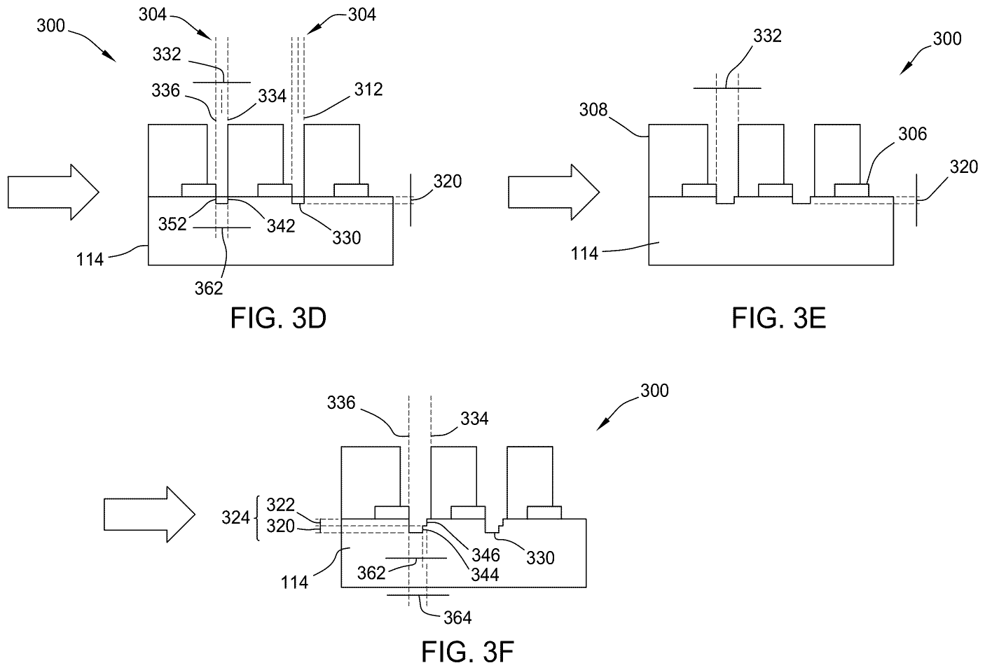

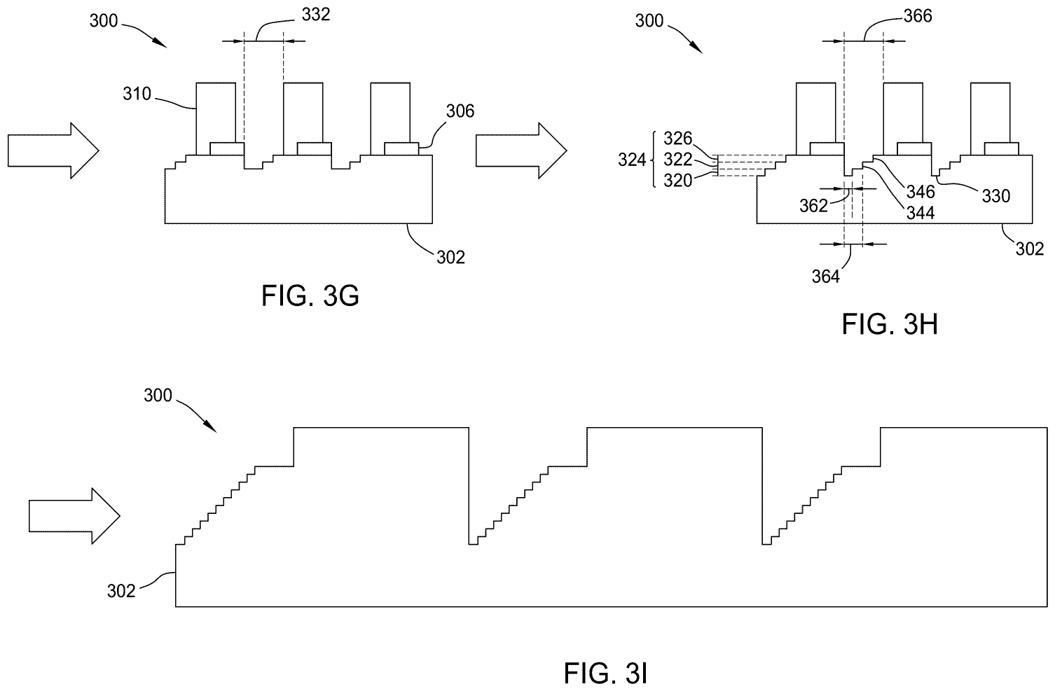

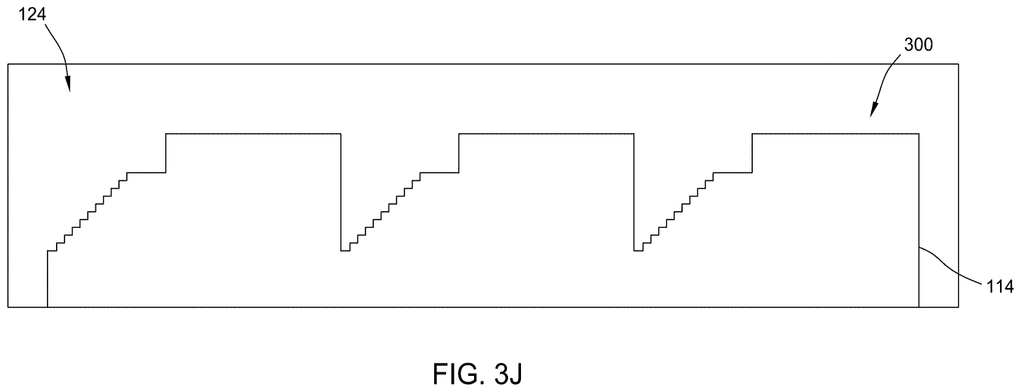

FIG. 2 is a flow diagram of a method 200 for forming a waveguide combiner 100. FIGS. 3A-31 show a portion 300 of a structure material 114. In one embodiment, the portion 300 corresponds to the first grating 104a of the waveguide combiner 100 to be formed.

As shown in FIG. 3A, prior to operation 202, a hardmask segment 306 is disposed and patterned on the structure material 114. The patterned hardmask includes a plurality of hardmask segments, such as a first hardmask segment 306a, a second hardmask segment 306b, and a third hardmask segment 306c that are separated from each other. The separation (e.g., distance) between the segments of the patterned hardmask will determine the width of each staircase structure produced. FIG. 3B is a schematic, cross-sectional view of the device layer 302 at operation 202. In operation 202, as shown in FIG. 3B, a photoresist layer 308 is deposited or otherwise placed over the hardmask segments 306.

At operation 204 and as shown in FIG. 3C, the photoresist layer 308 is exposed by lithography to produce a plurality of photoresist segments 310, such as a first photoresist segment, a second photoresist segment, and a third photoresist segment. The plurality of photoresist segments 310 are offset from the hardmask segments 306 such that the photoresist segments 310 directly contact and cover a portion of the structure material 114 and expose a portion of each hardmask segment 306. Further, the photoresist segments 310 do not extend to subsequent hardmask segments (e.g., from the first hardmask segment 306a to the second hardmask segment 306b). Rather, each photoresist segment 310 ends a distance from the subsequent hardmask segment.

At operation 206, plasma etchant 304 contacts the structure material 114 as shown in FIG. 3D. The structure material 114 is exposed to plasma etchant 304, such as radicals and ion beams, contacting the structure material 114. Exposing the structure material 114 to the plasma etchant 304 may include etching processes, such as ion etching and reactive ion etching (RIE). The plasma etchant 304 etches a first depth 320 of a plurality of depths 324 to produce a step 330 into the structure material 114. After operation 206, in addition to the first depth 320, the step 330 includes an initial leading sidewall portion 342 of a leading sidewall 344 (shown in FIG. 3D), a trailing sidewall 352, and a first linewidth 362 from the initial leading sidewall portion 342 to the trailing sidewall 352. The first linewidth 362 is controlled by a distance 332 between a leading edge plane 334 defined by a first side 312 of each photoresist segment 310 and a trailing edge plane 336 defined by an exposed side of each hardmask segment 306 contacting the structure material 114. The distance 332 corresponds to the first linewidth 362 as the plasma etchant 304 does not contact the structure material 114 outside of the distance 332.

At operation 208, photoresist segments 310a, 310b, and 310c are trimmed by an isotropic ion etching process that recesses the photoresist segments vertically and horizontally. This operation increases the distance from the first linewidth 362 (defined by initial leading sidewall portion 342 to the trailing sidewall portion) to the distance 332 between the leading sidewall 344 to the trailing edge plane 334.

Optionally, operations 206 and 208 may be repeated to etch a second depth 322 of a plurality of depths 324 of the step 330 into the structure material 114. As shown in FIG. 3E, each photoresist segment 310 is trimmed to decrease the width of each photoresist segment 310 such that the first side 312 of each photoresist segment 310 is shifted along the device layer 302, increasing the distance 332.

In addition to the second depth 322, the step 330 includes a second leading sidewall portion 346 and a second linewidth 364 from the second leading sidewall portion 346 to the trailing sidewall portion. The second linewidth 364 is controlled by the distance 332 between a leading edge plane 334 and a trailing edge plane 336 during the repeating of operations 206 and 208. As the distance 332 increases with each iteration of operations 206 and 208, the second linewidth 364 is longer than the first linewidth 362. The distance 332 corresponds to the second linewidth 364 as the plasma etchant 304 does not contact the structure material 114 outside of the distance 332. As shown in FIG. 3E, in various embodiments, the increase in the distance 332 between each photoresist segment 310 after trimming is uniform and equal to double the first linewidth 362, e.g., the second linewidth 364 is double the length of the first linewidth 362, such that each of the step 330 are symmetric. Alternatively, the second linewidth 364 may increase non-uniformly over, e.g., be non-uniformly greater than, the first linewidth 362. For example, the second linewidth 364 may increase by 1.5 times the first linewidth 362, producing a non-symmetric staircase or blazed grating. Similarly, subsequent linewidths may increase symmetrically or non-symmetrically.

Operation 206 and 208 are repeated until the waveguide combiner is formed when the step 330 has the plurality of depths 324 including the first depth 320 and the second depth 322 corresponding to a step depth, as shown in FIGS. 3G and 3H. Decreasing the first depth 320 and each second depth 322 will result in a smoother leading sidewall of the step 330. For example, the photoresist segments 310 are trimmed, further increasing the distance 332. A third depth 326 of the plurality of depths 324 is created along with a third leading sidewall portion and a third linewidth 366 from the third leading sidewall portion to the trailing sidewall 352. The third linewidth 366 is controlled by the distance between the leading edge plane 334 and the trailing edge plane 336. The distance 332 corresponds to the third linewidth 366 as the plasma etchant 304 do not contact the structure material 114 outside of the distance 332.

Operations 206 and 208 are repeated to produce a trim width 118. The trim width 118 can be less than a top width 116 of the staircase structure. Optionally, the trim width 118 can be greater than the top width 116 of the stair case structure. Operations 208 and 208 are repeated to produce an intermediate step 132, wherein the intermediate step includes an intermediate width 120 that is less than the trim width 118.

At operation 210, the patterned hardmask and the photoresist layer 308 include non-transparent materials and are removed at after the waveguide combiner is formed, as shown in FIG. 31. For example, the patterned hardmask and the photoresist layer 308 include reflective materials, such as Cr or silver (Ag). In another embodiment, the patterned hardmask and the photoresist layer 308 include transparent materials such that the patterned hardmask and the photoresist layer 308 remain after the waveguide combiner is formed.

After operation 210, the step 330 remains and forms the staircase structures 106. Although only ten steps and one intermediate step is shown in FIG. 31, operations 206 and 208 may be repeated to produce a desired amount of steps, such as 5, such as 10, such as 25, with an intermediate step. As the number of steps increases, it is noted that the linewidth of each step (e.g., 362, 364) may decrease, producing a smoother leading sidewall portion (e.g., 342, 344) for each staircase structure 106. For example, the method 200 may enable the formation of a plurality of staircase structures 106 that each approximate a continuous blazed profile.

At operation 212, as shown in FIG. 3J, an encapsulation layer 124 is disposed on the structure material 114. The encapsulation layer 124 may be formed using one or more vapor deposition processes which utilize plasma such as PVD or sputtering processes, a furnace CVD (FCVD) process, a PE-CVD process, a PE-ALD process, or other plasma processes.

The waveguide combiner 100 described herein includes staircase structures 106. Each staircase structure 106 includes a plurality of staircase steps 110. The aggregation of the plurality of staircase steps 110 formed a staircase surface 108. The staircase surface 108 formed by the plurality of staircase steps 110 provides for staircase structures 106 with the equivalent optical functionality of blazed structures. The methodology of repeating lithography and etch processes allows for the plurality of staircase steps 110 to be formed with controlled dimensions to result in the staircase surface.

While the foregoing is directed to embodiments of the present disclosure, other and further embodiments of the disclosure may be devised without departing from the basic scope thereof, and the scope thereof is determined by the claims that follow.

What is claimed is:

1. A waveguide combiner, comprising:
a substrate; and
a plurality of staircase structures disposed on the substrate, each staircase structure comprises:
a plurality of staircase steps, each staircase step having a staircase width that is the same, the plurality of staircase steps having a trim width from an initial staircase step to a final staircase step; and
a top step having a top width.

2. The waveguide combiner of claim 1, wherein each staircase structure of the plurality of staircase structures comprises a staircase surface.

3. The waveguide combiner of claim 2, wherein the staircase surface comprises a facet normal of each of the staircase steps parallel to the staircase surface of the substrate.

4. The waveguide combiner of claim 3, wherein the staircase surface comprises a staircase angle defined by the staircase surface and the facet normal.

5. The waveguide combiner of claim 4, wherein the staircase angle of two staircase structures of the plurality of staircase structures are different.

6. The waveguide combiner of claim 4, wherein the staircase angle of two staircase structures of the plurality of staircase structures are the same.

7. The waveguide combiner of claim 6, wherein the two staircase structures of the plurality of staircase structures have different depths.

8. The waveguide combiner of claim 1, wherein each staircase step has a staircase height that is the same.

9. The waveguide combiner of claim 1, wherein the plurality of staircase structures comprise oxides, carbides, or nitrides of silicon, aluminum, zirconium, tin, tantalum, zirconium, barium, titanium, hafnium, lithium, lanthanum, cadmium, niobium, or combinations thereof.

10. The waveguide combiner of claim 1, wherein the substrate comprises amorphous dielectrics, non-amorphous dielectrics, crystalline dielectrics, polymers, or combinations thereof.

11. The waveguide combiner of claim 1, wherein the substrate comprises silicon (Si), silicon dioxide (SiO₂), germanium (Ge), silicon germanium (SiGe), sapphire, or combinations thereof.

12. The waveguide combiner of claim 1, wherein the substrate is configured to transmit wavelengths from 100 to 3000 nanometers.

13. The waveguide combiner of claim 1, wherein each staircase structure of the plurality of staircase structures has a refractive index of about 1.5 to about 4.0.

14. The waveguide combiner of claim 1, wherein each staircase structure of the plurality of staircase structures has a refractive index of about 2.65 to about 4.0.

15. A waveguide combiner, comprising:
a substrate; and
a plurality of staircase structures disposed on the substrate, each staircase structure comprises:
a plurality of staircase steps, each staircase step having a staircase width that is the same, the plurality of staircase steps having a trim width from an initial staircase step to a final staircase step;
an intermediate step having an intermediate width; and
a top step having a top width.

16. The waveguide combiner of claim 15, wherein the intermediate step is disposed between the final staircase step and the top step.

17. The waveguide combiner of claim 15, wherein the substrate is configured to transmit wavelengths from 100 to 3000 nanometers.

18. The waveguide combiner of claim 15, wherein each staircase structure of the plurality of staircase structures has a refractive index of about 1.5 to about 4.0.

19. A method of forming a waveguide combiner, comprising:
depositing a photoresist layer on a patterned hardmask disposed on a device layer;
exposing the photoresist layer to produce a plurality of photoresist segments;
etching the device layer to produce a first step of a blazed grating having a staircase width;
trimming the plurality of photoresist segments horizontally;
repeating etching the device layer and trimming the plurality of photoresist segments horizontally to produce an intermediate step, the intermediate step having an intermediate width greater than the staircase width; and
removing the plurality of photoresist segments and the patterned hardmask.

20. The method of claim 19, further comprising disposing an encapsulation layer over the device layer.
